(19) United States
(12) Patent Application Publication
(10) Pub. No.: US 2019/0256728 A1
(43) Pub. Date: Aug. 22, 2019

(54) COMPOSITIONS BASED ON EMULSIONS OF WAX AND PARTICULATE INORGANIC COMPOUNDS FOR IMPROVED WATER-REPELLENCY, AND THE USE THEREOF

(71) Applicant: ISOGAMA INDUSTRIA QUIMICA LTDA, São José dos Pinhais (BR)

(72) Inventors: Giulio Pieter FORMENTI, Curitiba (BR); Bruno Cesar Ortiz UGARTE, São José dos Pinhais (BR)

(21) Appl. No.: 16/321,323

(22) PCT Filed: Jul. 28, 2017
(86) PCT No.: PCT/BR2017/050213

§ 371 Date: Apr. 29, 2019

(30) Foreign Application Priority Data
Jul. 28, 2016 (BR) PCT/BR2016/050175

(51) Int. Cl. C09D 15/00; C09D 191/06; C09D 7/45; C09D 7/61; C09D 7/40; B27N 7/00

(52) U.S. Cl. CPC C09D 15/00; C09D 191/06; C09D 7/45; C08K 2003/343; C09D 7/68; C09D 7/69; B27N 7/005; C09D 7/61

(57) ABSTRACT

Compositions based on wax emulsions and particulate inorganic compounds for improved water repellency are described, based on wax emulsions and particulate inorganic compounds for improved water repellency comprising, as a percentage of the total composition, 5% to 90% water, 0.01% to 20% surfactants, 2% to 90% waxes and 2% to 90% particulate inorganic compounds with a particle size of between/among 0.01 μm and 1000 μm, selected from among unmodified phyllosilicates such as agalmatolite, potassium aluminosilicate, talc, manganese silicate, or mixtures thereof in any proportion, added before or after the emulsification of the said waxes, and presenting a synergistic effect of increased water repellency when the said compositions are applied, preferably on reconstituted wood, composite panels.

### FIELD OF THE INVENTION

This invention belongs to the wax emulsions field, more specifically wax emulsions associated with particulate inorganic compounds, particularly those used in the manufacturing process of reconstituted wood sheets obtained from wood composite materials such as MDP (Medium Density Particleboard), MDF (Medium Density Fiberboard), OSB (Oriented Strand Board) and HDF (High Density Fiberboard), among others, especially single-component emulsions prepared from natural or synthetic waxes associated with certain inorganic compounds, whose synergistic effect leads to a substantial increase in the water repellency of these materials and consequently a significant reduction in substrate water absorption.

### BACKGROUND OF THE INVENTION

Specialists are well aware that wood composite materials are used for a wide variety of applications, mainly for commercial and residential construction materials. All parts of the tree which is the main feedstock for all the end products of this industry have some use and value in the process. After the bark is peeled off a felled tree, it may be converted into a set of forms that vary quite widely, chipping and/or cutting it into different sizes/textures, or blending it was some type of resin before pressing/molding. The final outcome of the process is a wood composite designed for specific applications.

For these wood composites and all the applications mentioned above, the permeability/porosity of these substrates allows water molecules to penetrate through their pores, resulting in problems related to dimension, structure, mechanical resistance, durability and appearance, among others.

These problems may be overcome through the use of improved or modified formulations, through selecting appropriate additives and different wax compositions, necessarily taking emulsification reactions into consideration, as well as the most appropriate particle size for each application, together with the manufacturing process in general.

Thus, in order to lessen the permeability of these materials, principally wood composites, wax emulsions are normally used, which may be followed by the separate application of inorganic materials such as silane-based additives, forming a barrier against encroaching moisture.

However, the disadvantage is that applying wax emulsions and inorganic compounds separately undermines the evenness of the application, leading to a consequent loss in impermeability efficiency and the dimensional stability of the substrate to which these materials are applied. This lowers the performance of the end product, while also leading to higher costs, due to the introduction of an additional application step.

In general, a wax may be emulsioned in water when it is melted and surfactants are used, which may be anionic (sodiums, ammoniums or other fatty acid anions) (see U.S. Pat. No. 2,244,685 A), non-ionic and cationic, followed by stirring and homogenization through pressurization (see U.S. Pat. No. 3,865,606 A) or ultrasound irradiation. A hydrophobic inorganic material may be obtained from nature, synthesized or mixed (see U.S. Pat. No. 5,183,710 A), and may be dispersed in water or a solvent, using some dispersing agent or some rheological agent, or stirring (see US 20080287554 A1). This inorganic matter may be functionalized with hydrophobic agents such as silanes, long-chain fatty acids, fluorinated compounds, polymers and other materials, for an enhanced hydrophobic effect.

These materials may be used separately as hydrophobic agents, in the form of wax emulsion films (see U.S. Pat. No. 4,468,254 A), using inorganic compounds with a sealant (see US 20140208978 A1). The wax emulsion may be used inside the materials when a waterproof barrier is desired (see EP 1509580 A4).

Consequently, an in-depth analysis of the state of the art located emulsions that use compounds with a water repellent function. As a result, it may be noted in French patent document FR 2952814131 that, for example: “Cold emulsified composition comprises fatty phase, aqueous phase and particulate phase comprising organically modified phyllosilicates able to be positioned itself at the oil-water interface to exclusively generate oil in water emulsion”, with prior filing date of Nov. 23, 2009, filed by Ephyla Sas, teaching a cold emulsified composition that comprises a fatty phase, an aqueous phase and a particulate phase comprising organically modified phyllosilicates that can be positioned at the oil-water interface in order to generate exclusively an oil in water emulsion.

This document discloses an oil in water emulsion that is used particularly for cosmetic purposes, with the disadvantage that it does not present sufficient water repellent effects for application to woods.

Moreover, published US Patent Application 2003176537A1 for “Composite materials with improved phyllosilicate dispersion” addresses phyllosilicates with edges modified by anionic surfactants, composite materials made from these phyllosilicates and methods for the production thereof. In sundry embodiments, the phyllosilicates are described with surfaces altered by agents modifying the hydrophilic-lipophilic balance (HLB), polymer hydrotropes and antioxidants. This publication also provides mixtures of such phyllosilicates and semi-crystalline waxes. The composite materials are prepared through the dispersal of the said phyllosilicates with polymers, particularly polyolefins and elastomers.

Consequently, this patent document teaches only the dispersal of phyllosilicates in polymer materials, unconnected to the characteristics presented for the subject of the proposed invention, as it does not define any convenient composition for application to the above-mentioned substrates, whereby the application of such phyllosilicates results in effects that potentiate water repellency in these materials.

Finally, published US Patent Application 2003187120A1 for “Coatings and films derived from clay/wax nanocomposites” describes methods for making clay/wax nanocomposites and coatings and films of same with improved chemical resistance and gas barrier properties. The invention addressed by this publication further provides methods for making and using the said emulsions of such clay/wax nanocomposites. Typically, an organophilic clay is combined with a wax or wax/polymer blend such that the cohesion energy of the clay matches that of the wax or wax/polymer blend. Suitable organophilic clays include mica and phyllosilicates that have been surface-treated with edge or edge and surface modifying agents. The resulting nanocomposites have applications as industrial coatings and in protective packaging.

Thus, in addition to this patent document addressing the field of nanocomposites, whose manufacturing processes are highly complex and extremely expensive on the downside, no compositions are presented that would be appropriate for the applications proposed by the invention.

A gap is thus noted at the prior art in terms of wax-based emulsions with added particulate inorganic compounds, particularly agalmatolite. Agalmatolite consists mainly of two aluminum phyllosilicates pyrophyllite (Al₂O₃.4SiO₂.H₂O) and muscovite (K₂O.3Al₂O₃.6SiO₂.2H₂O), in association with minerals such as: sericite (a variety of finely crystallized muscovite), quartz, kyanite, andalusite, diaspore, and feldspar. As ancillary minerals, the presence of rutile, zircon, and tourmaline is common. Depending on its mineralogy, agalmatolite may be white, cream, gray, greenish and purple. Inert, agalmatolite has a density of density 2.7 to 3.0 and hardness between 2.5 and 3.0.

In addition to agalmatolite, minerals such as potassium aluminosilicate, talc and manganese silicate are materials that are useful for the purposes of the invention, as they provide a synergistic effect of increasing the water repellency of these emulsions, thus offering the possibility of less water absorption in composite materials made from reconstituted wood. These particulate minerals offer a competitive advantage, as the current means of water absorption reduction through the use of additives that are already known (such as silane-based additives, for example) have high acquisition costs and also generate additional handling outlays.

Striving to solve these problems and offset these disadvantages, this invention proposes wax-based emulsions associated with particulate inorganic compounds, that present a synergistic effect of enhanced water repellency for the said emulsions.

Consequently, a purpose of this invention is to contribute to the dimensional stability of the substrate, in order to solve performance problems at low cost, when compared to conventional emulsions and/or waxes whose compositions are only wax-based. The swelling and absorption tests mentioned below in greater detail offer sufficient indications of dimensional stability for technical experts in this field.

Furthermore, due to the high water-repellent performance and better yield of this composition, another purpose of this invention is to use particulate inorganic materials that offer economic benefits, compared to products that are solely wax-based, as they do not require the use of other additives that are more expensive.

As an advantage, this invention proposes the formation of a unique product, composed of an association of waxes and particulate inorganic compounds, that can offer a greater reduction in water absorption, lowering production costs and with easier application, thus enhancing the performance of the proposed product in terms of water repellency.

### SUMMARY OF THE INVENTION

This invention addresses an emulsion that is based on waxes or a wax composition, and one or more particulate inorganic compounds, either pure or mixed in any proportion, whose purpose is to deploy the synergy between the waxes and the particulate inorganic compounds to reduce water absorption and enhance the dimensional stability of the substrate.

Wax compositions with the above-mentioned mineral additives offer the key benefit of reducing water absorption, while also contributing to the dimensional stability of the substrate, compared to conventional emulsions and/or waxes with compositions based only on waxes.

Due to the high water repellent performance and better yield of these compositions, their economic benefits can be perceived easily, compared to products that are only wax-based.

The combination of an inorganic particulate additive with a wax-based emulsion and/or a wax composition has a synergistic effect, conferring a high level of water repellency on the substrate. As a result of this level of water repellency, a reduction in water absorption is noted, particularly compared to current ways of reducing water absorption through silane-based additives whose costs are high, and also require additional handling steps.

In the particle size range of 0.01 μm to 1000 μm, preferably 20 μm to 60 μm, particulate inorganic compounds are derived from minerals that synergistically increase the water repellency effects of these emulsions. The particulate inorganic compounds are selected from among agalmatolite, potassium aluminosilicate, talc, and manganese silicate. The order in which the particulate inorganic compounds are introduced is not critical, as they may be added before or after the emulsification of the waxes.

The compositions addressed by the invention based on wax emulsions and particulate inorganic compounds in order to provide improved water repellency are thus comprised of a fatty phase, an aqueous phase and an inorganic particulate phase, selected from among non-modified phyllosilicates such as agalmatolite, potassium aluminosilicate, talc and manganese silicate, with a particle size of between 0.01 μm and 1000 μm, specifically with a particle size of between 20 μm and 60 μm.

The compositions addressed by the invention comprise, in percentage by weight of the total weight of the composition:

a) Water at 5% to 90%, specifically 30% to 50%;

b) Surfactants at 0.01% to 20%, specifically 0.5% to 3%;

c) Waxes at 2% to 90%, specifically 35% to 60%; and

d) Particulate inorganic compounds in a proportion of 2% to 90%, specifically 5% to 35%.

### DETAILED DESCRIPTION OF THE INVENTION

Wax emulsions receive additives consisting of particulate inorganic compounds with a particle size of 0.01 μm to 1000 μm, preferably 20 μm to 60 μm, from minerals that endow these emulsions with a synergistic effect of increased water repellency, with this effect being more intense when the size of each particle is between 20 μm and 60 μm, as these particles are better distributed on the substrate.

Associating particulate inorganic compounds with emulsions potentiates the water repellent effect of the waxes, due to oriented adsorption of the surfactant molecules, where the polar or hydrophilic region of the molecule anchors the inorganic compound through electrostatic effects, while the apolar portion tends to remain in the outer region, associating with the waxes in the emulsion. This novel system increases the hydrophobic characteristic of the substrate when the product is applied to the substrate, particularly particulate wood.

Particulate inorganic compounds that are useful for the purposes of the invention are selected from among phyllosilicates such as unmodified agalmatolite, potassium aluminosilicate, talc, manganese silicate or mixtures thereof in any proportion, added before or after the emulsification of the waxes, with the intention of applying these emulsions mainly to panels made from reconstituted wood composites.

In a preferred embodiment, the emulsion addressed by the invention is produced through the use of homogenization agents and is then mixed with the inorganic compound(s). The emulsion resulting from this process is applied to particulate wood during panel manufacturing processes, and is thus incorporated into the panel structure.

The emulsion addressed by the invention is composed of: i. water, used as a carrier; ii. waxes, used as water repellent agents and chosen from among: minerals selected from among vaseline, paraffin, microcrystalline petroleum wax, slack wax, ozocerite, lignite wax, peat wax; plants selected from among soybeans, palms, flax, candelilla, carnauba, ricin and olive, esters; animals, selected from among beeswax, lanolin, beef fat derivatives; or synthetic, selected from among polyethylene wax and Fischer-Tropsch wax; iii. surfactants, used as emulsifying agents, that may be anionic, selected from among sodium, potassium, ammonium and other fatty acid soaps; fatty acids and sulfated, sulfonated, phosphate, malleated benzene derivatives non-ionics, selected from among polyvinyl derivatives, acrylate derivatives, woodpulp derivatives, ethoxylated fatty alcohols, sulfated, sulfonated phosphated and ethoxylated malleated benzene derivatives, etc; and cationics: tertiary fatty amine derivatives; alkyl benzene amine derivatives and similar ethoxyelated products; and iv. particulate inorganic compounds, used as water repellent agents, selected from among calcium and magnesium carbonate, dolomite, limestone, barite, kaolin, mica, pyrophyllite, manganese and aluminum silicate, gypsum, plaster, calcium sulfate, titanium dioxide, silicon dioxide, iron oxides, chrome oxides, antimony oxides, aluminum oxides and hydroxides, unmodified phyllosilicates such as agalmatolites, bentonite, montmorillonite, hectorite, saponite, and illite, phyllosilicates and variations thereof. The inorganic compounds are used alone or in combinations among them, in any proportion. In a preferred embodiment, the inorganic compound used is agalmatolite.

The wax-based composition addressed by the invention is comprised within the following boundaries:

a) water at 5% to 90%, specifically at 30% to 50%, by weight in terms of the total weight of the composition;

b) surfactants at 0.01% to 20%, specifically at 0.5% to 3%, by weight in terms of the total weight of the composition;

c) waxes at 2% to 90%, specifically at 35% to 60%, by weight in terms of the total weight of the composition; and

d) particulate inorganic compounds at 2% to 90%, specifically at 5% to 35%, by weight in terms of the total weight of the composition, with a particle size of 0.01 μm to 1000 μm, specifically 20 μm to 60 μm.

Consequently, in a preferred embodiment, the particulate inorganic compounds are potassium, magnesium and aluminum silicate, with unmodified phyllosilicates selected from among agalmatolite, mica, pyrophyllite, muscovite or mixtures thereof, used pure or combined in any proportion.

Furthermore, the particulate inorganic compounds are alternatively defined as calcium and magnesium carbonates, dolomite, limestone, barite, kaolin, mica, pyrophyllite, agalmatolites, manganese and aluminum silicate, gypsum, plaster, calcium sulfate, titanium dioxide, silicon dioxide, iron oxides, chrome oxides, antimony oxides, aluminum oxides and hydroxides, bentonite, montmorillonite, hectorite, saponite, and illite, unmodified phyllosilicates or mixtures thereof, used pure or combined in any proportion.

In one embodiment of the invention, the composition consists of an aqueous paraffin emulsion produced as described below, as percentages of the total weight of the composition:

a) 48% water

b) 35% paraffin selected from among vaseline, paraffin, microcrystalline petroleum wax, slack wax, ozocerite, lignite wax, peat wax, soybeans, palms, flax, candelilla, carnauba, ricin and olive, esters, beeswax, lanolin, beef fat derivatives, polyethylene wax and Fischer-Tropsch wax; and

c) 2% surfactant selected from among sodium, potassium and ammonium soaps and made from fatty acids; fatty acids and sulfated, sulfonated, phosphated, malleated benzene derivatives; polyvinyl derivatives, acrylate derivatives, woodpulp derivatives, ethoxylated fatty alcohols, sulfated, sulfonated phosphated and ethoxylated malleated benzene derivatives, etc; tertiary fatty amine derivatives; alkyl benzene amine derivatives and similar ethoxyelated products; and

d) 15% particulate inorganic compounds selected from among unmodified phyllosilicates, including agalmatolite, potassium aluminosilicate, talc and manganese silicate, pure or mixed among themselves in any proportion.

### Example 1

A paraffin emulsion with the composition as described above was applied on an industrial chipboard production line. A reduction in dosage was also used in order to prove the enhanced performance.

The performance data for the composition addressed by the invention in terms of swelling and water absorption are listed in Table 1 below, including the industrial plant acceptance limits. It may be noted that, even with a 25% dosage reduction on the inner layer, the swelling and absorption results (tests conducted in compliance with the ABNT NBR 14810:2013 Standard established by the Brazilian Technical Standards Association) were acceptable and close to the initial performance.

TABLE 1

| | | Panels leaving the | | | | | |
|---|---|---|---|---|---|---|---|
| | | press | | | | | |
| Emulsion dosage | | | Absorption | Sanded panels | | | |
| Dosage | Dosage | Swelling 2 | 2 hours, | Swelling 2 | Absorption | Swelling 24 | Absorption |
| internal | external | hours, % | % (max. | hours, % | 2 hours, % | hours, % | 24 hours, % |
| layer, % | layer, % | (max. 8%) | 35%) | (max. 8%) | (max. 35%) | (max. 16%) | (max. 70%) |
| 0.40 | 0.35 | 7.50 | 26.33 | 6.01 | 19.88 | 11.82 | 39.90 |
| 0.40 | 0.35 | 7.00 | 26.75 | 6.32 | 20.45 | 10.43 | 36.75 |
| 0.35 | 0.30 | 7.86 | 29.79 | 7.45 | 21.13 | 12.83 | 43.52 |
| 0.35 | 0.30 | 7.96 | 31.37 | | | | |
| 0.35 | 0.30 | 7.30 | 26.60 | | | | |
| 0.30 | 0.30 | 7.86 | 31.08 | 7.95 | 22.00 | 11.07 | 37.52 |
| 0.30 | 0.30 | 7.84 | 29.57 | | | | |

### Example 2

As shown in the following Table, laboratory tests of paraffin emulsion applied to MDP panels, with and without inorganic compounds that were assessed for swelling and water absorption in compliance with the ABNT NBR 14.810:2003 Standard issued by the Brazilian Technical Standards Association (ABNT) showed less swelling and absorption for emulsions with inorganic compounds. In both cases, the paraffin emulsion had 52% total solids; in the emulsion with an inorganic compound, 30% its paraffin was replaced by an inorganic compound.

TABLE 2

| | Swelling | Absorption | | Absorption |
|---|---|---|---|---|
| | 2 hours | 2 hours | Swelling 24 | 24 hours |
| | (%) | (%) | hours (%) | (%) |
| Emulsion without | 3.5 | 17.5 | 10.1 | 47.0 |
| inorganic | | | | |
| compound | | | | |
| Emulsion with | 2.7 | 15.6 | 8.5 | 44.9 |
| 30% inorganic | | | | |
| compound | | | | |

It must be clear to specialists that this invention is not limited to the representations mentioned or illustrated here, but must rather be understood in its broader scope. Many modifications and other representations of the invention will come to mind for a person versed in the art to which this invention belongs, with the benefit of the teachings presented in the above descriptions in this Report.

Furthermore, it is understood that this invention is not limited to the specific form disclosed, whereby modifications and other forms are understood as included within the scope of the Claims appended hereto. Although specific terms are employed here, they are used only in a generic and descriptive sense, with no intention of imposing constraints.

1) A composition based on wax emulsions and particulate inorganic compounds for improved water repellency comprising by percentage of weight of the total composition:
a. water at 5% to 90%;
b. surfactants at 0.01% to 20%;
c. waxes at 2% to 90%; and
d. particulate inorganic compounds at 2% to 90%, with a particle size between 0.01 μm to 1000 μm.

2) The composition according to claim 1, comprised by percentage of weight of the total composition of 30% to 50% water, 0.5% to 3% surfactants, 35% to 60% waxes, and 5% to 35% particulate inorganic compounds with a particle size of 20 μm to 60 μm.

3) The composition according to claim 1, comprising:
a. 48% water;
b. 35% wax;
c. 2% surfactants; and
d. 15% particulate inorganic compounds.

4) The composition according to claim 1, wherein the waxes are selected from the group consisting of: minerals, selected from the group consisting of: vaseline, paraffin, microcrystalline petroleum wax, slack wax, ozocerite, lignite wax, and peat wax; plant, selected from the group consisting of: soybean, palm, flaxseed, candelilla, carnauba, ricin, olive waxes, and esters; animal, selected from the group consisting of: beeswax, lanolin, beef lard derivatives; and synthetic, selected between polyethylene wax and Fischer-Tropsch wax; and combinations thereof.

5) The composition according to claim 4, wherein the wax is paraffin.

6) The composition according to claim 1, wherein the particulate inorganic compounds is selected from the group consisting of: calcium and magnesium carbonate, dolomite, limestone, barite, kaolin, mica, unmodified phyllosilicates including pyrophyllite, agalmatolites, manganese silicate and aluminum, gypsum, plaster, calcium sulfate, titanium dioxide, silicon dioxide, iron oxides, chrome oxides, antimony oxides, aluminum oxides and hydroxides, bentonite, montmorillonite, hectorite, saponite; and illite, and combinations thereof.

7) The composition according to claim 6, wherein the particulate inorganic compound is unmodified agalmatolite.

8) A method for treating sheets of reconstituted wood obtained from wood composite materials, by applying the compositions according to claim 1.

9) The method according to claim 8, wherein the reconstituted wood is selected from the group consisting of; MDP (Medium Density Particleboard), MDF (Medium Density Fiberboard), OSB (Oriented Strand Board) and HDF (High Density Fiberboard).

10) (canceled)
